(19) United States
(12) Patent Application Publication
(10) Pub. No.: US 2023/0139373 A1
(43) Pub. Date: May 4, 2023

(54) BREAKAWAY ELECTRICAL CONNECTOR

(71) Applicant: Hubbell Incorporated, Shelton, CT (US)

(72) Inventors: William Henry Dietz, Branford, CT (US); Thomas Louis Scanzillo, Monroe, CT (US); Roy Itzler, Orange, CT (US)

(73) Assignee: Hubbell Incorporated, Shelton, CT (US)

(21) Appl. No.: 18/052,688

(22) Filed: Nov. 4, 2022

Related U.S. Application Data
(60) Provisional application No. 63/275,573, filed on Nov. 4, 2021.

(51) Int. Cl. H01R 13/62; B60D 1/64

(52) U.S. Cl. CPC H01R 13/6205; B60D 1/64; H01R 2201/26

(57) ABSTRACT

A breakaway electrical connector is provided that includes a line side and a load side. The line side that is connectable to a line conductor, while the load side is connectable to a load conductor. The line side has a first magnet and a first plurality of contacts. The load side has a second magnet and a second plurality of contacts. The first and second magnets provide a magnetic connection force to maintain the line and load sides connected to one another with the first and second plurality of contacts electrically coupled to one another.

### CROSS REFERENCE TO RELATED APPLICATIONS

This application claims the benefit of U.S. Application 63/275,573 filed Nov. 4, 2021 the contents of which are incorporated by reference herein.

### BACKGROUND

### 1. Field of the Invention

The present disclosure is related to electrical connectors. More particularly, the present disclosure is related to breakaway electrical connectors.

### 2. Description of Related Art

It is becoming common for vehicles such as, but not limited to tractor trailers, trains, campers, load trailers, and others, to have a temporary need for a supply of electrical power provided by something other than the engine of the vehicle that is supplying the driving power.

For example, refrigerated tractor trailers often have a need to power the refrigerators to maintain the cargo in a refrigerated state, while the truck is stopped as can occur at loading/unloading locations or when stationary during a driving break. In another example, camping trailers often have a need to power one or more consumer devices (lights, HVAC, etc.) when the camping trailer is a stationary location.

In order to maintain greenhouse gas emissions at a minimum, it is also common for such locations to have prohibitions against idling—namely require the user to stop the vehicle engine to prevent un-necessary use of fuels, while mitigating the amount of associated exhaust gases.

Many of these locations provide a power source, which allows the trailer to connect while stopped. These power sources typically involve an outlet or other plug for temporary connection by the trailer. These connections can be damaged in the event of an accidental drive off, namely when the trailer is moved without disconnection from the outlet or plug.

Accordingly, it has been determined by the present disclosure that there is a need for breakaway electrical connectors that overcome, alleviate, and/or mitigate one or more of the aforementioned and other deleterious effects of prior the art.

### SUMMARY

A breakaway electrical connector is provided that includes a line side and a load side. The line side that is connectable to a line conductor, while the load side is connectable to a load conductor. The line side has a first magnet and a first plurality of contacts. The load side has a second magnet and a second plurality of contacts. The first and second magnets provide a magnetic connection force to maintain the line and load sides connected to one another with the first and second plurality of contacts electrically coupled to one another.

In some embodiments either alone or together with any one or more of the aforementioned and/or after-mentioned embodiments, the first and second magnets are arranged so that the first plurality of contacts can only be electrically coupled to the second plurality of contacts in a defined pattern.

In some embodiments either alone or together with any one or more of the aforementioned and/or after-mentioned embodiments, the first plurality of contacts each include a front portion, a rear portion, and a biasing member. The rear portion is connectable to the line conductor. The front portion is movable with respect to the rear portion along a connection axis. The biasing member normally biases the front and rear portions apart to define an air gap therebetween.

In some embodiments either alone or together with any one or more of the aforementioned and/or after-mentioned embodiments, the first plurality of contacts are configured so that the air gap of a first of the first plurality of contacts closes before the air gap of a remainder of the first plurality of contacts.

In some embodiments either alone or together with any one or more of the aforementioned and/or after-mentioned embodiments, the magnetic connection force is lower than a pull-apart strength of the line side and the load side.

In some embodiments either alone or together with any one or more of the aforementioned and/or after-mentioned embodiments, the line side has a first fitting configured to connect to the line conductor and the load side has a second fitting configured to connect to the load conductor. The magnetic connection force is lower than a pull-apart strength of the first and second fittings.

In some embodiments either alone or together with any one or more of the aforementioned and/or after-mentioned embodiments, the first magnet and the second magnet are multiple pole magnets.

In some embodiments either alone or together with any one or more of the aforementioned and/or after-mentioned embodiments, the first and second magnets each have polarities arranged so that the first plurality of contacts can only be electrically coupled to the second plurality of contacts in a defined pattern.

In some embodiments either alone or together with any one or more of the aforementioned and/or after-mentioned embodiments, the first magnet is a plurality of first magnets and the second magnet is a plurality of second magnets.

In some embodiments either alone or together with any one or more of the aforementioned and/or after-mentioned embodiments, the first and second plurality of magnets are arranged so that the first plurality of contacts can only be electrically coupled to the second plurality of contacts in a defined pattern.

The above-described and other features and advantages of the present disclosure will be appreciated and understood by those skilled in the art from the following detailed description, drawings, and appended claims.

### DESCRIPTION OF THE DRAWINGS

FIG. 1 is a perspective view a breakaway electrical connector according to an exemplary embodiment of the present disclosure in a connected state;

FIG. 2 is a perspective view of a load side of the breakaway electrical connector of FIG. 1,

FIG. 3 is an end view of the load side of FIG. 2;

FIG. 4 is a perspective view of a line side of the breakaway electrical connector of FIG. 1;

FIG. 5 is an end view of the line side of FIG. 4;

FIG. 6 is a first sectional view of the breakaway electrical connector of FIG. 1 in a normal or disconnected connected state;

FIG. 7 is the first sectional view of the breakaway electrical connector of FIG. 1 in a first partially connected state;

FIG. 8 is the first sectional view of the breakaway electrical connector of FIG. 1 in a second partially connected state;

FIG. 9 is a second partial sectional view of the breakaway electrical connector of FIG. 1 in a connected state; and

FIG. 10 illustrates an exemplary embodiment of a set of multipole magnets for use with the breakaway electrical connector of FIG. 1.

### DETAILED DESCRIPTION

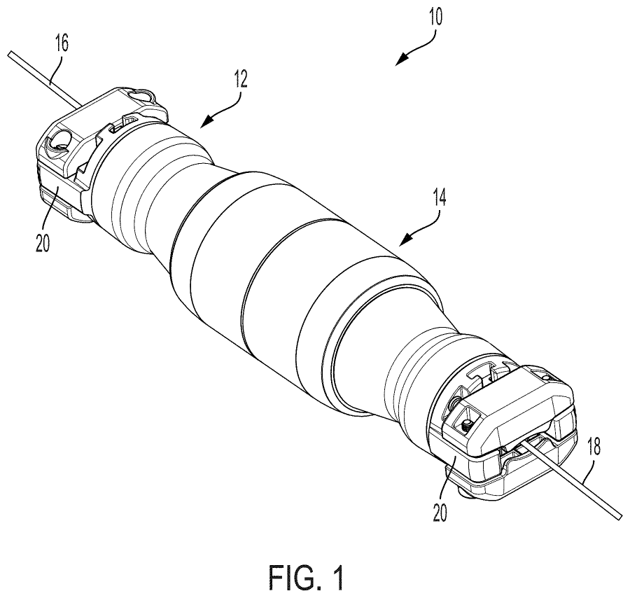

Referring to the drawings and in particular with simultaneous reference to FIGS. 1-5, an exemplary embodiment of a breakaway electrical connector according to the present disclosure is shown and is generally referred to by reference numeral 10.

Connector 10 includes a line side 12 and a load side 14 connected to line conductor 16 and a load conductor 18, respectively. In the illustrated embodiment, sides 12, 14 each have a water-tight compression fitting 20 for connection to conductors 16, 18. Fitting 20 allows sides 12, 14 to be wired directly to the existing conductors 16, 18 on vehicles and stationary power supplies.

Of course, it is contemplated by the present disclosure for sides 12, 14 to be connected to conductors 16, 18 in any desired manner.

Connector 10 includes one or more magnets 22 arranged on each of line side 12 and load side 14. In the illustrated embodiment, sides 12, 14 each have four magnets 22. Of course, it is contemplated by the present disclosure for sides 12, 14 to have more or less than four magnets 22 each.

Advantageously, connector 10 provides an industrial grade, horsepower rated connector with sides 12, 14 that are magnetically secured to one another via magnets 22 with a magnetic force that can be disconnected or broken apart when sufficient axial and/or transverse loading—such as can occur in accidental drive off situations—without damage to either side 12, 14, conductors 16, 18, or fittings 20.

Stated differently, the magnetic connection provided to connector 10 by magnets 22 is sufficient to maintain sides 12, 14 connected to one another during normal operation, but this magnetic connection is less than the pull-apart strength of sides 12, 14 and of fittings 20, as well as being less than a tensile strength of conductors 16, 18. As used herein, the term “pull-apart strength” shall mean the strain relief limits of fittings 20.

In the illustrated embodiment, connector 10 is shown as a four-contact connector where line and load sides 12, 14 each have a ground contact 24, a neutral contact 26, and one or more hot contacts 28, 30 (two shown).

Of course, it is contemplated by the present disclosure for connector 10 to be configured with any desired configuration of contacts. Moreover, it is contemplated by the present disclosure for connector 10 to be configured for use with one or more different voltages such as, but not limited to, voltages from 12 to 480.

Connector 10 can include one or more alignment features.

In some embodiments, line side 12 can have a guide opening 32 and load side 14 can have a corresponding guide protrusion 34. Opening 32 receives protrusion 34 so as to align line side 12 and load side 14 to one another during assembly. In the illustrated embodiment, opening 32 and protrusion 34 are shown centrally arranged in sides 12, 14, respectively and have symmetrical configurations with four sides arranged in a cross-shape.

Of course, it is contemplated by the present disclosure for opening 32 and protrusion 34 to have any desired configuration. For example, opening 32 and protrusion 34 can have non-symmetrical shapes and/or can be non-concentrically arranged. In these embodiments, the shapes and/or arrangement of opening 32 and protrusion 34 can ensure proper connection of line side 12 and load side 14 to one another via alignment of contacts 24, 26, 28, 30.

In some embodiments either alone or in combination with opening 32 and protrusion 34, connector 10 can be configured so that the arrangement of magnets 22 provide, in addition to the aforementioned magnetic connection force, alignment of contacts 24, 26, 28, 30.

The alignment via magnets 22 can be seen with reference to the end views of sides 12, 14 shown in FIGS. 3 and 5. The polarity of the magnets 22 have been arranged in a manner that sides 12, 14 can only be assembled such that contacts 24, 26, 28, 30 of the two sides are properly mated.

For example, sides 12, 14 can be configured such that magnets 22 having a positive or southern polarity are arranged on the left-hand side of ground and neutral contacts 24, 26, while the magnets having a negative or north polarity are arranged on the right-hand side of ground and neutral contacts 24, 26.

Due to this exemplary arrangement of magnets 22 with respect to ground and neutral contacts 24, 26, the magnets 22 would repel sides 12, 14 from one another during attempts to assembly connector 10 such that side 12 with ground 24 at the top and neutral 26 at the bottom to side 14 with neutral 26 at the top and ground 24 at the bottom. Further, this exemplary arrangement of magnets 22 with respect to ground and neutral contacts 24, 26, results in the magnets 22 attracting sides 12, 14 towards one another during attempts to assembly connector 10 such that sides 12, 14 both having ground 24 at the top and neutral 26 at the bottom.

Of course, the present disclosure contemplates other arrangements of magnets 22 and contacts 24-30 with respect to one another that ensures the desired alignment of the contacts on sides 12, 14.

In some embodiments either alone or in combination with the alignment capability provided by opening 32/protrusion 34 and/or magnets 22, connector 10 can be configured so that one or more of contacts 24-30 can function as alignment features.

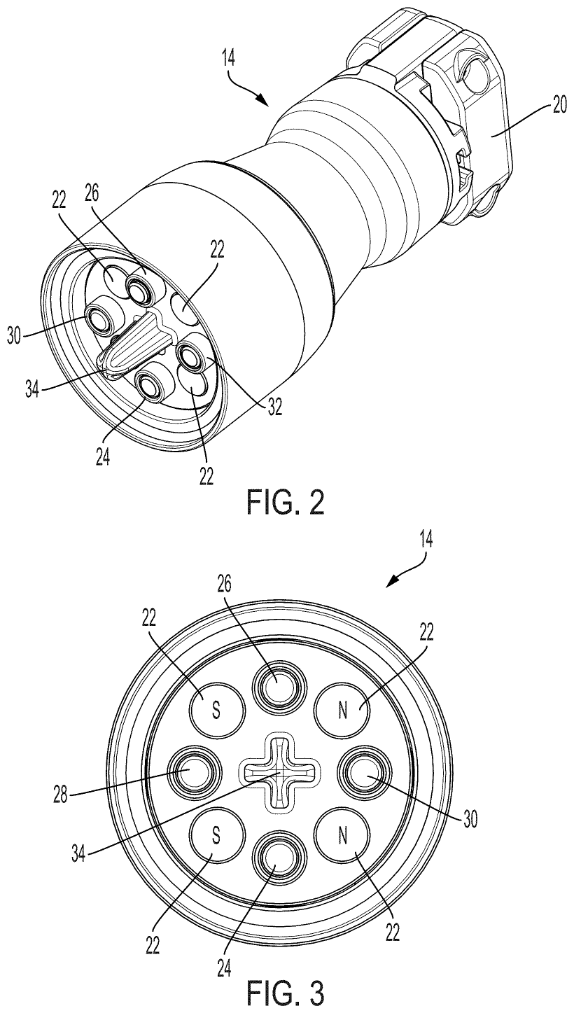

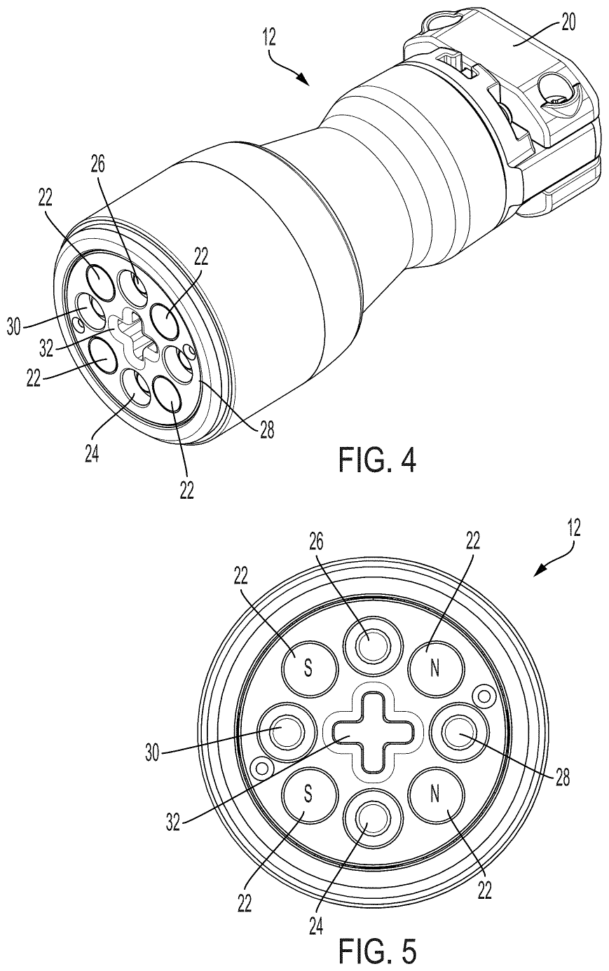

The alignment via contacts 24-30 can be seen with reference to the perspective views of sides 12, 14 shown in FIGS. 2 and 4. Here, it can be seen that contacts 24, 26, 28, 30 on load side 14 protrude or extend outward, while the contacts on the line side 12 are recessed inward.

The recessed contacts 24-30 of line side 12 are configured to receive the protruding contacts 24-30 of load side 14 so as to align the line and load sides to one another during assembly.

In the illustrated embodiment, the recessed and protruding contacts 24-30 are shown having a common size and shape. Of course, it is contemplated by the present disclosure for only the contacts on sides 12, 14 that are intended to mate with one another to have a common shape to provide further alignment assurance.

As shown, connector 10 is configured so that line side 12 includes opening 32 and recessed contacts 24-30—which correspond to an outlet, while load side 14 includes protrusion 34 and protruding contacts 24-30—which correspond to a male plug. In this configuration, connector 10 is configured to provide a familiar look and feel to normal outlets and plugs.

Line side 12 is connected to a power source and, thus, can present a hazardous condition much like an electrical outlet if one were to contact one or more of contacts 24-30. Thus, the recessed nature of contacts 24-30 on line side 12 can provide a degree of safety to prevent inadvertent electrical communication with the contacts.

Of course, it is contemplated by the present disclosure for the recessed and protruding components to be formed on sides 12, 14 in any desired manner.

In some embodiments, connector 10 can be configured to provide for a specific order of connection among contacts 24, 26, 28, 30.

For example, connector 10 can be configured so that ground contacts 24 on sides 12, 14 mate before any of the remaining contacts 26, 28, 30 mate with one another. Further, connector 10 can be configured so that neutral contacts 26 on sides 12, 14 mate after ground contacts 24 are mated, but before hot contacts 28, 30 mate. Finally, connector 10 can be configured so that hot contacts 28, 30 on sides 12, 14 mate after ground and neutral contacts 24, 26 are mated with one another, respectively.

Connector 10 is further configured to so that this order of mating (i.e., ground first, neutral second, and hot last) occurs in reverse during disconnection of line and load sides 12, 14.

Accordingly, connector 10 can be configured so that the distance each pair of mating contacts are recessed in and/or protrude from line and load sides 12, 14, respectively, provide the desired ordered mating of contacts 24-30.

In some embodiments, connector 10 can be leave one or more of the contacts 24-30 on line side 12 unenergized until at least partially mated with load side 14. In this manner, line side 12 is presented with a dead front end—namely with one or more of contacts 24-30 in a de-energized state—until the line side is mated with load side 14.

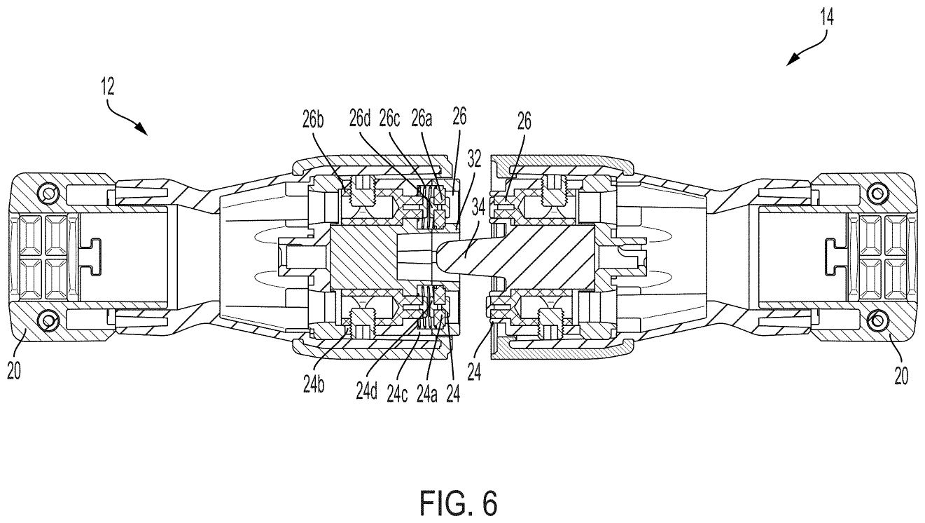

The specific order of mating of contacts 24-30 and the dead front end of line side 12 are described in more detail with simultaneous reference to FIGS. 6-9.

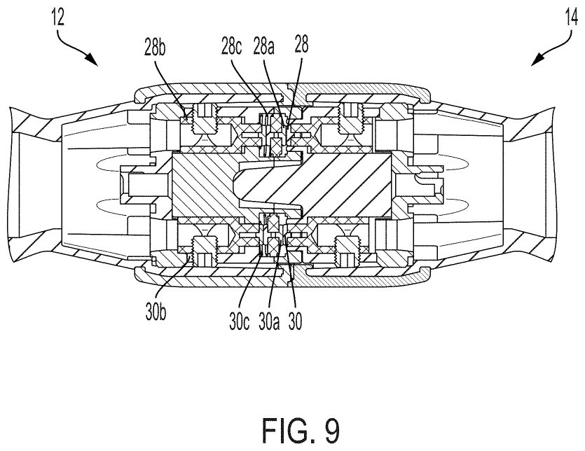

Connector 10 is shown in FIGS. 6-8 via a first cross section that passes through ground contact 24 and neutral contact 26 such that the order of mating and dead front end of connector 10 are discussed with respect to contacts 24, 26. Connector 10 is shown in FIG. 9 via a second cross section, taken ninety degrees from the first cross section of FIGS. 6-8, that passes through hot contacts 28, 30.

FIG. 6 illustrates connector 10 in a normal or disconnected state. Here, guide protrusion 34 of load side 14 is being received in guide opening 32 into line side 12 so as to start the mating of the line and load sides—while none of the contacts 24, 26, 28, 30 have yet mated with one another.

Ground contact 24 has a front portion 24a, a rear portion 24b, and a biasing member 24c. Front portion 24a is positioned for connection with the corresponding ground contact 24 of load side. Front portion 24a is movable along an axis of the mating movement of connector 10 and is normally biased by biasing member 24c away from rear portion 24b. Rear portion 24b is operatively connected to supply conductor (not shown) and, thus, is energized by the supply conductor.

In the normal position shown in FIG. 6, biasing member 24c forms an air gap 24d between front and rear portions 24a, 24b of ground contact 24. Biasing member 24c is electrically isolated from at least one—and preferably both—front and rear portions 24a, 24b of ground contact 24. In this manner, ground contact 24 is configured so that electrical energy cannot be conducted from rear portion 24b to front portion 24a in the normal position.

Neutral contact 26 is similarly constructed and, thus, also has a front portion 26a, a rear portion 26b, and a biasing member 26c that result in an air gap 26d between the front and rear portions in the normal position of FIG. 6.

Although not shown, hot contacts 28, 30 are also similarly constructed and, thus, have an air gap between the front and rear portions in the normal position of FIG. 6.

As shown, the front portions 24a, 26a of contacts 24 and 26 (as well as the unshown contacts 28, 30) on line side 12, although connected to the supply conductor, are not energized—providing the line side of connector 10 with a “dead front end”.

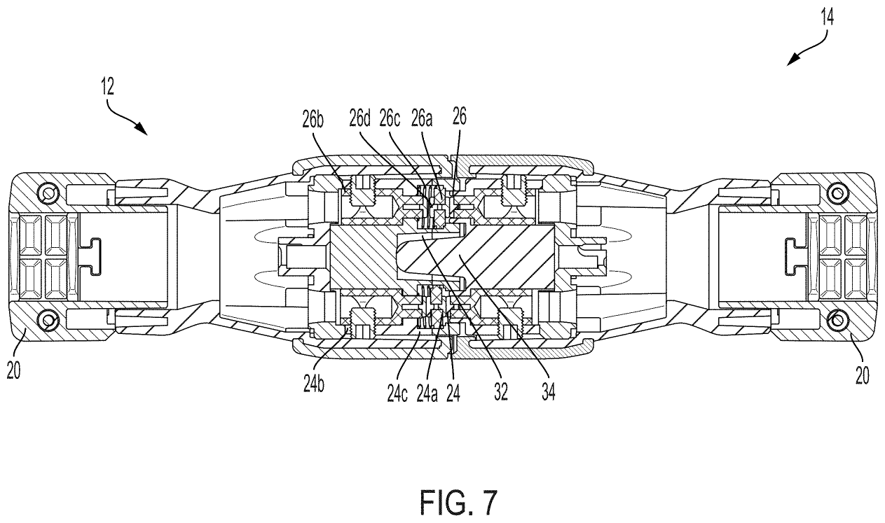

FIG. 7 illustrates connector 10 in a partially connected state.

Here, ground contact 24 of line side 12 and ground contact 24 of load side 14 have contacted with one another. It can be seen that the force of contacts 24 of line and load sides 12, 14 on one another has compressed biasing member 24c to the point where air gap 24d has been closed with front and rear portions 24a, 24b of ground contact 24 of the line side in electrical contact with one another. This position places the front portion 24a in electrical communication with the supply conductor through rear portion 24b and places front portion 24a in electrical communication with the corresponding ground contact 24 on load side 14.

It can also be seen that air gap 26d of neutral conductor 26 remains—with front and rear portions 26a, 26b of the neutral contact 26 electrically isolated from one another, such that the front portion 26a is electrically isolated from supply conductor.

Air gap 26d remains due to one or more dimensions of connector 10.

In one embodiment, line side 12 can be configured such that neutral contact 26 is recessed more as compared to ground contact 24. In other embodiments, load side 14 can be configured such that ground contact 24 protrudes more as compared to neutral contact 26. In still other embodiments, line side 12 can be configured such that air gap 24d of ground contact 24 is smaller than air gap 26d of neutral contact 26.

Of course, it is contemplated by the present disclosure for connector 10 include one or more of these or other dimensional constraints sufficient to ensure that during mating of line and load sides 12, 14 the front and rear portions 24a, 24b mate prior to the front and rear portions 26a, 26b.

Although not shown, it can be appreciated that since hot contacts 28, 30 are also similarly constructed, these hot contacts also still have an air gap between the front and rear portions in the partially connected state of FIG. 7.

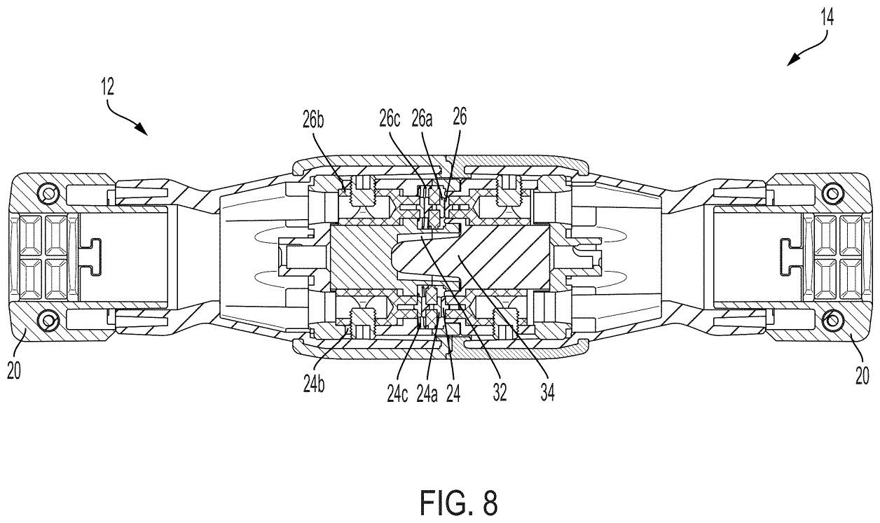

FIG. 8 illustrates connector 10 in a second partially connected state, namely after mating of ground contacts 24 and neutral contacts 26.

Here, it can be seen that biasing member 26c has also been compressed to a point where air gap 26d has been closed with front and rear portions 26a, 26b of neutral contact 26 in electrical contact with one another. This position places the front portions 24a, 26a in electrical communication with the supply conductor through rear portions 24b, 26b and places front portions 24a, 26a in electrical communication with the corresponding ground and neutral contacts 24, 26 on load side 14.

FIG. 9 illustrates connector 10 in a connected state, namely after mating of ground contacts 24, neutral contacts 26, and hot contacts 28, 30.

Biasing members 28c, 30c have also been compressed to a point where the respective air gaps have been closed with front and rear portions hot contacts 28, 30 in electrical contact with one another, respectively. To provide the aforementioned front dead end, connector 10 is configured so that the air gaps of hot contacts 28, 30 are closed after air gap 26d of neutral contact 26.

Disconnection of line and load sides 12, 14 is the reversal of the above-described process, where hot contacts 28, 30 reform the respective air gaps prior to neutral contact 26, which in turn reforms its air gap prior to ground contact 24.

In some embodiments, one or more of contacts 24, 26, 28, 30 are recessed in a manner so as to form an insulating shield around the contact so that in the event of arcing at the air gaps during connection and disconnection are protected.

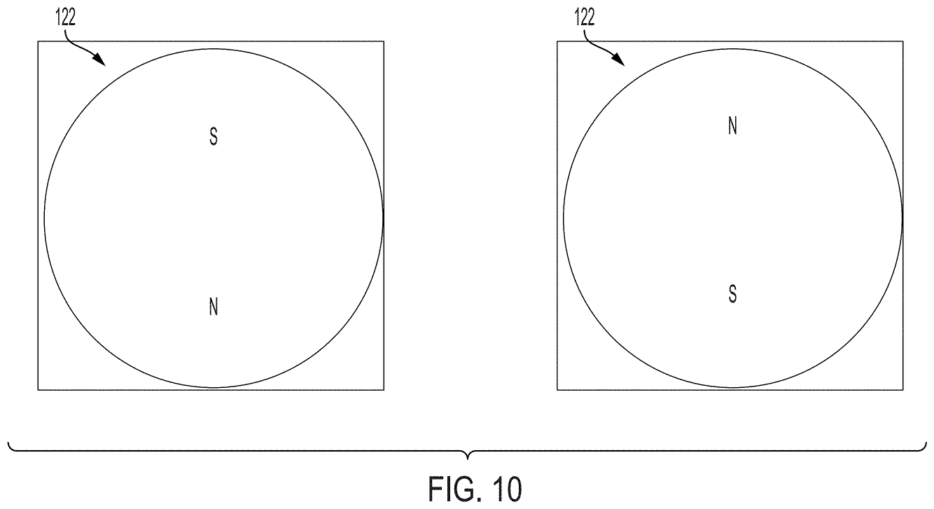

It should be recognized that connector 10 is illustrated by way of example only as having multiple magnets 22 on each of line and load sides 12, 14. However, it is contemplated by the present disclosure for connector 10 to include embodiments having a single magnet 122 on each side 12, 14. Magnet 122 is described in more detail with reference to FIG. 10.

Magnet 122 is illustrated as a two-pole magnet—namely having both a positive or southern polarity and a negative or northern polarity. Connector 10 can be configured to have one magnet 122 on line side 12 and one magnet 122 on load side 14. The magnets 122 are positioned on sides 12, 14 with the polarity arranged in a manner that the sides can only be assembled with contacts 24, 26, 28, 30 of the two sides properly mated. As shown, one magnet 122 (left hand side of FIG. 10) can have the southern polarity at the top and the other magnet 122 (right hand side of FIG. 10) can have the southern polarity at the bottom.

Of course, it is contemplated by the present disclosure for sides 12, 14 to have the single magnets 122 with other arrangements that ensure contacts 24, 26, 28, 30 of the two sides are properly mated. Moreover, it is contemplated by the present disclosure for connector 10 to have more that one magnet 122 on each side 12, 14 and/or to include a combination of single pole magnets 22 and multipole magnets 122.

Connector 10 provides the advantage of eliminating of costly and untimely repairs of damaged electrical wiring systems due to accidental drive off while sides 12, 14 are connected. Connector 10 further provides these benefits together with an easy to mate configuration, which provides multiple levels of security to eliminate incorrect mating of the line to the load, yet can break away under excessive stress.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

PARTS LIST

| | |
|---|---|
| breakaway electrical connector 10 | front portion 24a |
| line side 12 | rear portion 24b |
| load side 14 | biasing member 24c |
| line conductor 16 | air gap 24d |
| load conductor 18 | front portion 26a |
| fitting 20 | rear portion 26b |
| magnets 22 | biasing member 26c |
| ground contact 24 | air gap 26d |
| neutral contact 26 | front portion 28a |
| hot contacts 28, 30 | rear portion 28b |
| guide opening 32 | biasing member 28c |
| guide protrusion 34 | front portion 30a |
| | rear portion 30b |
| | biasing member 30c |
| | magnet 122 |

What is claimed is:

1. A breakaway electrical connector, comprising:
a line side that is connectable to a line conductor, the line side having a first magnet and a first plurality of contacts; and
a load side that is connectable to a load conductor, the load side having a second magnet and a second plurality of contacts,
wherein the first and second magnets provide a magnetic connection force to maintain the line and load sides connected to one another with the first and second plurality of contacts electrically coupled to one another.

2. The breakaway electrical connector of claim 1, wherein the first and second magnets are arranged so that the first plurality of contacts can only be electrically coupled to the second plurality of contacts in a defined pattern.

3. The breakaway electrical connector of claim 1, wherein the first plurality of contacts each comprise a front portion, a rear portion, and a biasing member, the rear portion being connectable to the line conductor, the front portion being movable with respect to the rear portion along a connection axis, the biasing member normally biasing the front and rear portions apart to define an air gap therebetween.

4. The breakaway electrical connector of claim 3, wherein the first plurality of contacts are configured so that the air gap of a first of the first plurality of contacts closes before the air gap of a remainder of the first plurality of contacts.

5. The breakaway electrical connector of claim 1, wherein the magnetic connection force is lower than a pull-apart strength of the line side and the load side.

6. The breakaway electrical connector of claim 1, wherein the line side comprises a first fitting configured to connect to the line conductor and the load side comprises a second fitting configured to connect to the load conductor, wherein the magnetic connection force is lower than a pull-apart strength of the first and second fittings.

7. The breakaway electrical connector of claim 1, wherein the first magnet and the second magnet are multiple pole magnets.

8. The breakaway electrical connector of claim 7, wherein the first and second magnets each comprise polarities arranged so that the first plurality of contacts can only be electrically coupled to the second plurality of contacts in a defined pattern.

9. The breakaway electrical connector of claim 1, wherein the first magnet comprises a plurality of first magnets and the second magnet comprises a plurality of second magnets.

10. The breakaway electrical connector of claim 9, wherein the first and second plurality of magnets are arranged so that the first plurality of contacts can only be electrically coupled to the second plurality of contacts in a defined pattern.

11. A breakaway electrical connector, comprising:
a line side that is connectable to a line conductor, the line side having a first magnet with a first polarity and a first plurality of contacts; and
a load side that is connectable to a load conductor, the load side having a second magnet with a second polarity and a second plurality of contacts,
wherein the first and second plurality of contacts form an electrical connection when in contact with one another in a defined pattern,
wherein the first and second magnets and the first and second plurality of contacts are positioned and configured so that the first and second polarities attract the line and load sides towards one another when arranged in the defined pattern, but repel the line and load sides from one another when not arranged in the defined pattern.

12. The breakaway electrical connector of claim 11, wherein the first plurality of contacts each comprise a front portion, a rear portion, and a biasing member, the rear portion being connectable to the line conductor, the front portion being movable with respect to the rear portion along a connection axis, the biasing member normally biasing the front and rear portions apart to define an air gap therebetween.

13. The breakaway electrical connector of claim 12, wherein the first plurality of contacts are configured so that the air gap of a first of the first plurality of contacts closes before the air gap of a remainder of the first plurality of contacts.

14. The breakaway electrical connector of claim 11, wherein the first and second magnets provide a magnetic connection force that is lower than a pull-apart strength of the line side and the load side.

15. The breakaway electrical connector of claim 14, wherein the line side comprises a first fitting configured to connect to the line conductor and the load side comprises a second fitting configured to connect to the load conductor, wherein the magnetic connection force is lower than a pull-apart strength of the first and second fittings.

16. The breakaway electrical connector of claim 11, wherein the first magnet and the second magnet are multiple pole magnets.

17. The breakaway electrical connector of claim 11, wherein the first magnet comprises a plurality of first magnets and the second magnet comprises a plurality of second magnets.

18. The breakaway electrical connector of claim 17, wherein the first and second plurality of magnets are arranged so that the first plurality of contacts can only be electrically coupled to the second plurality of contacts in the defined pattern.
